(19) United States
(12) Patent Application Publication
(10) Pub. No.: US 2006/0031751 A1
(43) Pub. Date: Feb. 9, 2006

(54) Method for creating editable web sites with increased performance & stability

(76) Inventor: Shai Ehud, Holon (IL)

Correspondence Address: Shai Ehud, 25/2 Jericho St., Holon, 58549, IL

(21) Appl. No.: 11/127,168

(22) Filed: May 12, 2005

Related U.S. Application Data
(60) Provisional application No. 60/574,209, filed on May 26, 2004.

(51) Int. Cl. G06F 17/24

(52) U.S. Cl. 715/501.1

(57) ABSTRACT

A method, apparatus and computer program product for creating stable and editable web sites, which use efficient bandwidth, with fast response time and smooth web page transitions. The method creates a web page in the client's machine browser by combining layout instructions & content data. When navigating to a web page, the browser will try to fetch the layout or content data from the local cache, if not exists then the data will be fetched from a web server. This method allows cached layout data to be reused with different content data and edited web pages to be saved as content data. The method can also be used on mission critical systems as it gives the client computer the ability to smoothly overcome many server failures, by redirecting the client to an alternative server.

### CROSS-REFERENCE TO RELATED APPLICATIONS

This application is entitled to the benefit of Provisional Patent Application Ser. No. 60/574,209 filed May 26, 2004.

### BACKGROUND OF THE INVENTION

1. Field of the Invention

This invention relates to client/server computing in a World Wide Web (“Web”) environment, specifically to methods for one or more of the following: High performance web sites, web sites with enhanced stability and editable web sites.

2. Description of the Prior Art

The World Wide Web is the Internet's multimedia information retrieval system. In the Web environment, client machines effect transactions to Web servers using the Hypertext Transfer Protocol (HTTP), which is a known application protocol providing users access to computer files, using a standard page description language known as Hypertext Markup Language (HTML). HTML allows for the embedding of images, sounds, video streams, form fields and simple text formatting into a page. References to other pages or locations may also be embedded in the page using the URLs of the desired page or location.

To display the HTML pages, a browser is required. A browser is a computer program which enables a user to retrieve HTML pages from web servers. Use of an HTML-compatible browser (e.g., Microsoft Internet Explorer or other) at a client machine involves specification of a link via the URL. When the client makes a URL request to the web server, the URL link is identified and the web server returns a new HTML page that replaces the previous web page.

Due to the rapid grows of the World Wide Web (WWW), there is an astonishing growth in the amount of traffic and the amount of concurrent users connected to each server, this causes web server to be overloaded and increases the transfer delays of data between servers and the browsers accessing them. A method that implements smaller server transactions and better bandwidth utilization, will allow the same server hardware to support more concurrent users while the browsers accessing them will get faster response time.

This problem of improving bandwidth utilization can be partially solved by creating persistent object fragments from a named object in U.S. Pat. No. 6,249,844 to Jeffrey, 2001 Jun. 19. In this patent the HTML pages are analyzed in real time, in order to be able to cache and later reuse fragments of code. Jeffrey's patent has limitations such as the requirement to use a powerful web server that can analyze and deliver HTML content in real time, or the need to install binary code inside the client's machine in order to do real time content analyze.

When the browser makes a URL request, he gets from the server an entirely new web page, even if the same graphic layout is used again and only the text has changed. A method that will separate between the design of the page and the content of the page, while allowing the browser to insert new content inside the current displayed HTML page (instead of replacing the entire web page), will allow a faster response time, because only a small transaction is needed from the web server. Also the URL navigation will be smoother, because the web browser only updates the HTML page instead of replacing it with a new one.

The concept of separating the design (layout) of the page and the content of the page is used in patent application publication No. U.S. 20030018612, to Melbin, Jan. 23, 2003. In this invention web server caching is used to increase page production performance, but the limitation is the need to use powerful web servers. Moreover since the caching is done on the server side, there is no saving in bandwidth usage between the client and the web server.

The present invention solves these important problems and more.

### SUMMARY OF THE INVENTION

One object of the present invention is to overcome these and other deficiencies and drawbacks of existing web site creation tools, systems and methods.

The following list is a partial list of advantages of the present invention. By leveraging this technology, web application developers may realize a significant reduction in application development time and may also be able to develop more robust, bug-free applications.

### OBJECTS AND ADVANTAGES

Accordingly, besides the objects and advantages of the invention's method described above, several objects and advantages of the present invention are:
(a) High performance—The web client that runs in the browser respond faster then in conventional HTML site, this is due to the intensive use of cache elements, reuse of layout instructions & small server transactions. While traditional web technology stores together the content and graphic layout, in this technology changeable contents and graphic layouts are stored separately on the web server. When a web user asks for a new web page that uses the same layout as one of the previous pages, the system can fetch only the content file, and reuses the layout data stored in the application's cache memory.
(b) Better server utilization—Since the transactions are much smaller then used in traditional web sites (the server doesn't send to the web browser a complete web page), the same web server hardware can support more concurrent users.
(c) Better bandwidth utilization—Since the same information is passed in smaller transactions, the bandwidth utilization is more efficient.
(d) Easy editing of screen elements—there is no need to use complex admin tools, in this invention in order to change web page element, the application owner has to click on the item he wants to edit & change it's content directly on the HTML page (using WYSIWYG editor), the changes will be updated inside the local copy of the instruction data set and later on transmitted to the server.
(e) Easy Multilanguage support—Translation of the HTML UI to other languages, can be done easily, since the instruction data set can contain UI templates (layout data) that can be reused for many languages.
(f) Easy integration of new services—The web client can combine information from different sources located on different servers. This is done by fetching XML data from additional servers (for example fetching the layout data from the main server and the content data from sub servers) and combining all the information on the client's HTML page, this feature can also be used to do integration with legacy systems (the data can be exported in XML format).
(g) Offline usage—this technology can also work with simple XML files (instead of database system), and to be used in offline mode, by running it from a CD-Rom disk (for example when creating offline product catalog).
(h) Smooth web page navigation—In traditional technology the web page navigation is done by removing the current web page & displaying a blank screen till the new web page arrives. In this invention the content is replaced inside the current web page (the difference is that instead of replacing the entire web page, only the changed content is replaced inside the current displayed web page). The instruction data set stores display commands that specify where to put the new content and can also animate the changing content on the web page.
(i) Platform hub—application using the presented invention can act as a platform hub connecting web servers, database servers/services, e-commerce servers/services, legacy systems, or any of various other types of systems or services. The presented invention provides this service/system integration, and the ability to create centralized administrative or management tools for performing various aspects of system and application administration.
(j) Easy implementation of user sessions—Performing state and session management is especially important for applications that have complex, multi-step transactions. The present invention method can be used to easily maintain user state information during a user session or even across different user sessions in different domains.
   Other Objects and Advantages Are

This invention can also be used as a low cost solution and as an additional protection layer for mission critical systems. Many traditional mission critical system solutions suffer from drawbacks such as:
(a) They rely on a server unit that will redirect the web client to alternative servers when the current server fails to respond, but the web site will usually collapse if this server unit will be deactivated.
(b) The web site will fail to respond, if a web hacker will manage to block the access to the web domain (denial of service attack, router redirection or any other way).
(c) Traditional solutions will ensure that the web servers are working fine, but will fail to solve a client network latency problem.

This invention can overcome those problems and many more, by giving the web client the ability to connect to alternative servers. The client will use an alternative server when the current server will fail to supply the needed information or even when the server is working fine, but the response time is very slow, due to network latency or other problems.

In this invention mission critical systems can take advantage the following benefits:

(a) Better scalability—Additional replicated servers can be easily added to support more concurrent users.
(b) Better fault tolerance for mission critical systems—The web client can store a list of alternative servers, when one of the servers fails to supply the needed information (server crash, time-out error, file was deleted, low bandwidth, denial of service attack, hacker attack or any other reason), the information is taken from the next server in the list. The client can even be initialized from a static web site (or local storage device such as Hard-Disk) and then continue and read additional information from another location.
(c) Load balancing—The same server list used for fault tolerance, can be used for load balancing on normal conditions (when all servers are working), when a web server becomes overloaded, the client tries to use the next server in the list (till it finds a web server that can supply the data with reasonable response time). To create a load balancing server, there is no need to install server software, just to replicate the instruction data set to a new server.
(d) Session data—By storing the session data in the client, the client can use alternate server, without losing the data—a low cost solution for providing system reliability and fault tolerance, thus allowing a cheap solution for building web applications with greater scalability and better performance.

Further objects and advantages of the invention will become apparent from a consideration of the drawings and ensuing description.

Disadvantages

The present invention has some limitations that the implementers must be aware of:
(a). The present invention is not a shelf product, web sites will have to be converted in order to benefit from the advantages of the present invention.
(b). The present invention uses a client code that must be checked and minified on different kind of browsers, unsupported web browsers will have to be redirected to a web server that uses a standard HTML format.

### BRIEF DESCRIPTION OF THE DRAWINGS

The present invention can be better understood with reference to the following drawings. The elements of the drawings are not necessarily drawn to scale, emphasis instead being placed upon clearly illustrating the principles of the present invention. Furthermore, like reference numerals designate corresponding parts throughout the several views.

FIG. 1—Describes a basic system for displaying web pages.

FIG. 2—Describes an abstract system with edit and multi-server support.

FIG. 3A—Describes the flow of actions after a user click on an item on the web page.

FIG. 3B—Describes how the commands of the clicked item are handled.

FIG. 3C—Describes the XML node cache system.

FIG. 3D—Describes how data is parsed to display a web page.

FIG. 3E—Describes the process of page editing.

FIG. 4—Describes how updates are sent to the server in one session.

FIG. 5—Describes the simplest way to deploy the system.

FIG. 6—Describes advanced server deployment, with the use of services from additional web servers.

FIG. 7—Describes a suggestion on how to deploy the system in a way that will allow it to recover from fatal errors.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein, these embodiments are provided so that this disclosure will be thorough and complete, and will fully express the invention to those skilled in the art. Modifications and other embodiments are intended to be included within the scope of the appended claims. The implementation of this invention can use different variable names, programming languages, browser environments and data formats then specified in this description.

The Basic System

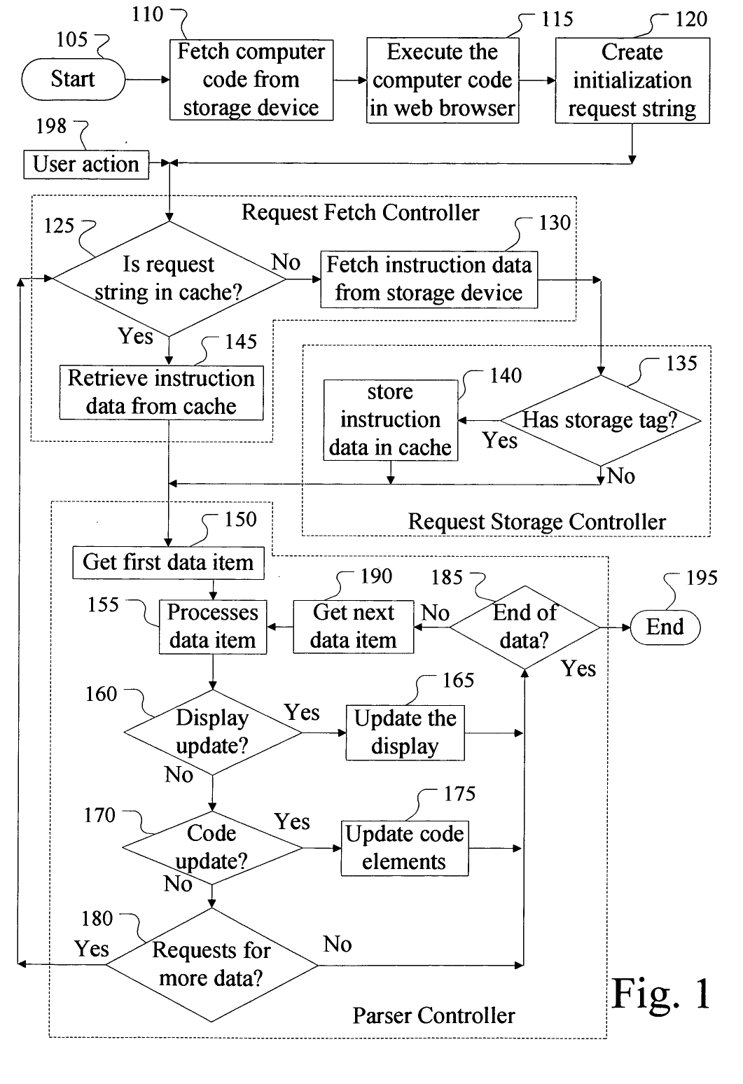

A basic system for displaying web pages is described in FIG. 1, this system will allow efficient running of web sites and web applications on a web browser. When a web user connects to a web site (or other storage device such as Hard-Disk), a JavaScript code is loaded along with the first HTML page (110), this code is parsed and executed by the web browser (115), next the code creates (120) initialization request string (which can be a URL address or file name), to fetch from the web server the first instruction data set (the instruction data set can be a XML file that contains fragments of HTML layout code and fragments of JavaScript code).

The Request Fetch Controller is responsible for fetching data from the local cache memory or from the storage device (such as a web server). If the request string in not in the cache memory (125), the data will be fetched from a web server or other storage device (130).

The Request Storage Controller is responsible for storing the data in the cache memory. If the data has storage tag (135), the data will be stored in the cache (140) for later reuse.

The Parser controller is responsible for parsing the instruction data set and executing the commands stored inside the instruction data set. The application retrieves the first data item in the instruction data set (150), the item is then processed to separate between commands and attributes (155). Display update commands (160), will update HTML fragments (or complete web page) inside the current displayed HTML page (165), this feature enables smooth web page navigation (smooth web page navigation without blinking, is achieved because changes are made inside the current displayed HTML page, instead of rendering a complete web page). Code update commands (170), will update code elements (add new functions, add new variables, update variables values), inside the application (175), this feature enables better code reuse (the application can use the same code with different data) and to enable more efficient code download (additional application code can be loaded when needed).

If the instruction data set contains reference to additional instruction data sets (180), the request string is used to load the additional instruction data set (125), this feature enables more efficient code reuse, by permitting code nesting. If the same request string (as the one stored in the application's cache) will be used again, the data will be fetched from the cache (145) to save network bandwidth, decrease the server load and allow a shorter response time.

If additional data item exists inside the instruction data set (185), then that item is fetched (190) and processed (155). The procedure terminates (195), after processing all the items (185). The procedure can be invoked again (198) when web browser users, clicks on HTML items on the web page, in that case the HREF attribute of the hyperlink tag, can store the request string (URL).

An Editable Multi-Server System

1. Prefix

The following is advanced implementation that is based on the same method as described in FIG. 1. This implementation has two basic modes of operation:
a. Normal mode—this mode is used to display the web site to the web users.
b. Edit mode—this mode is used to update and manage the site by an admin user.

The user's web browser can only use the ‘normal mode’, while the admin user can switch between the ‘normal mode’ and the ‘admin mode’ with a click of a button. The system uses code that runs inside the client's web browser, the code is loaded into the client's browser when the browser connects to the web site (or request a specific page inside the web site), that code can be written using JavaScript, VB Script, Java or any other programming language that can be used inside a web browser. For simplicity the instruction data set is separated into layout & content data, which are written using the XML format (XML is an acronym for Extensible Markup Language), but can also be used with other data formats. The data can be stored in the server's database or on a simple XML text files (storing the data in XML text files enables the web site the ability to be activated from CD-Rom or local Hard-Disk in the client's PC). This invention can be used on a single-server or multi-server configurations. When using a multi server configuration, some web browsers (like Microsoft Internet Explorer) may require enabling the security permission ‘Access data sources across domains’ to the specific domain of the web application.

2. System Init

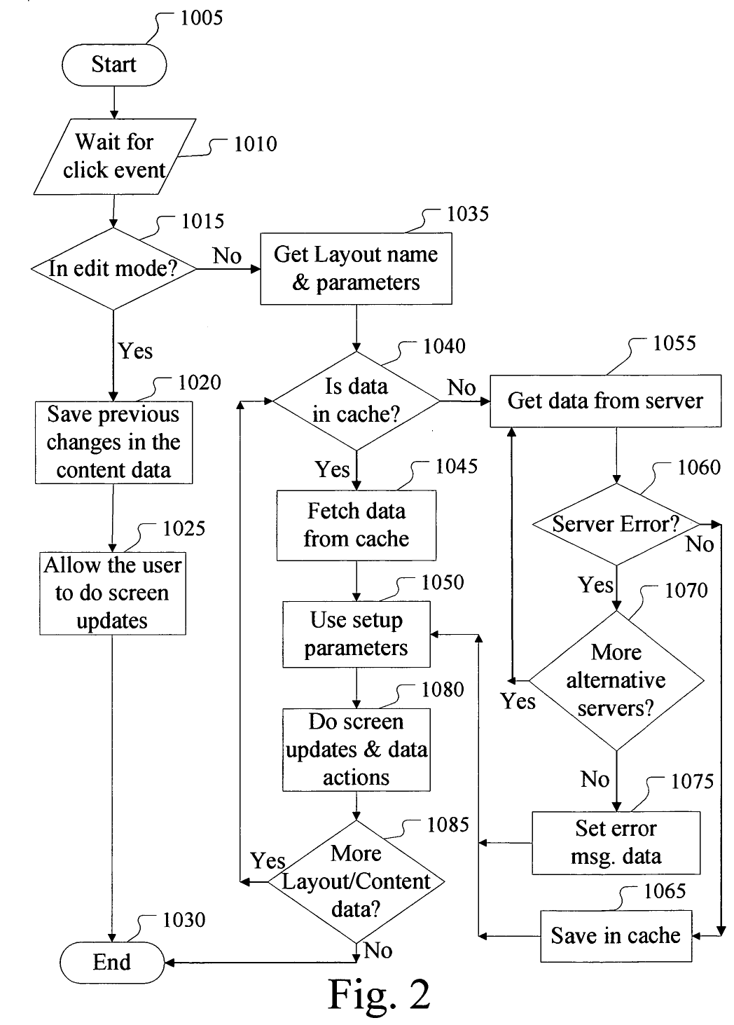

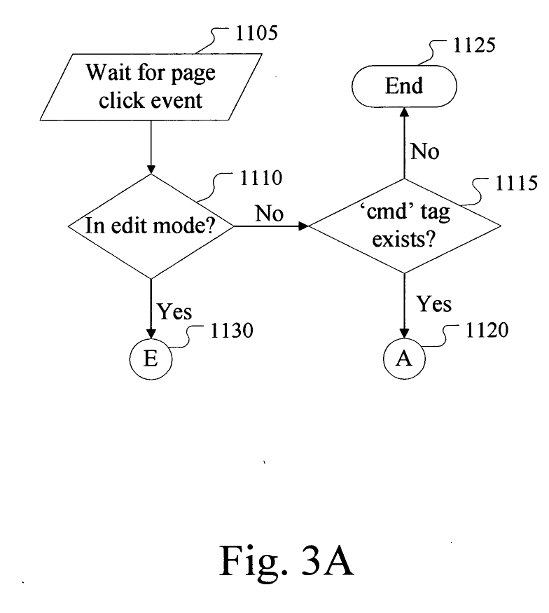

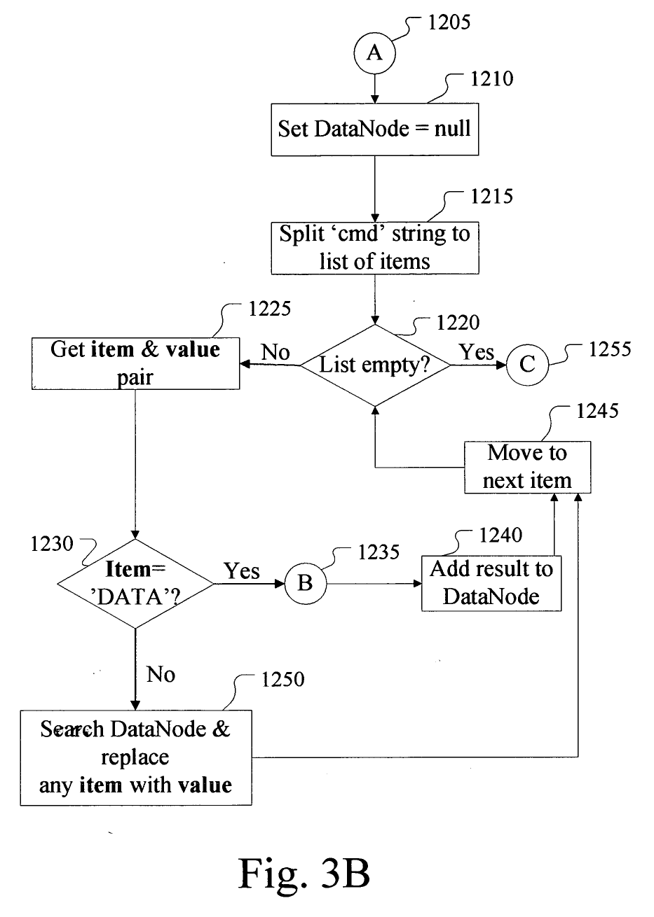

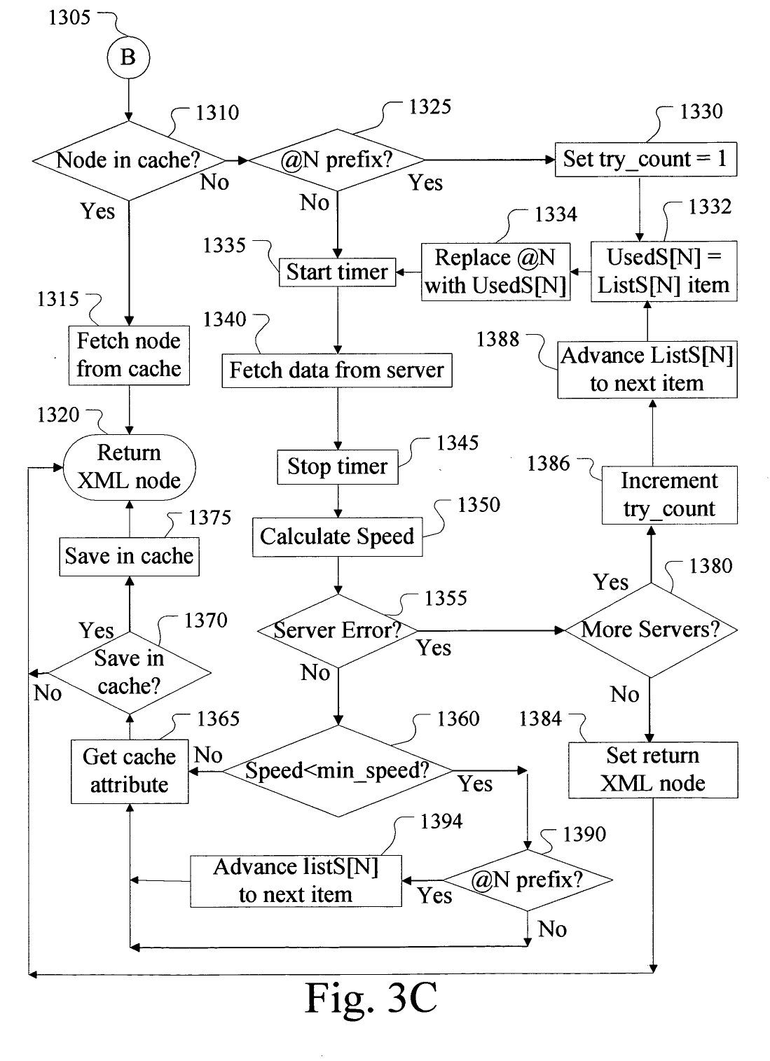

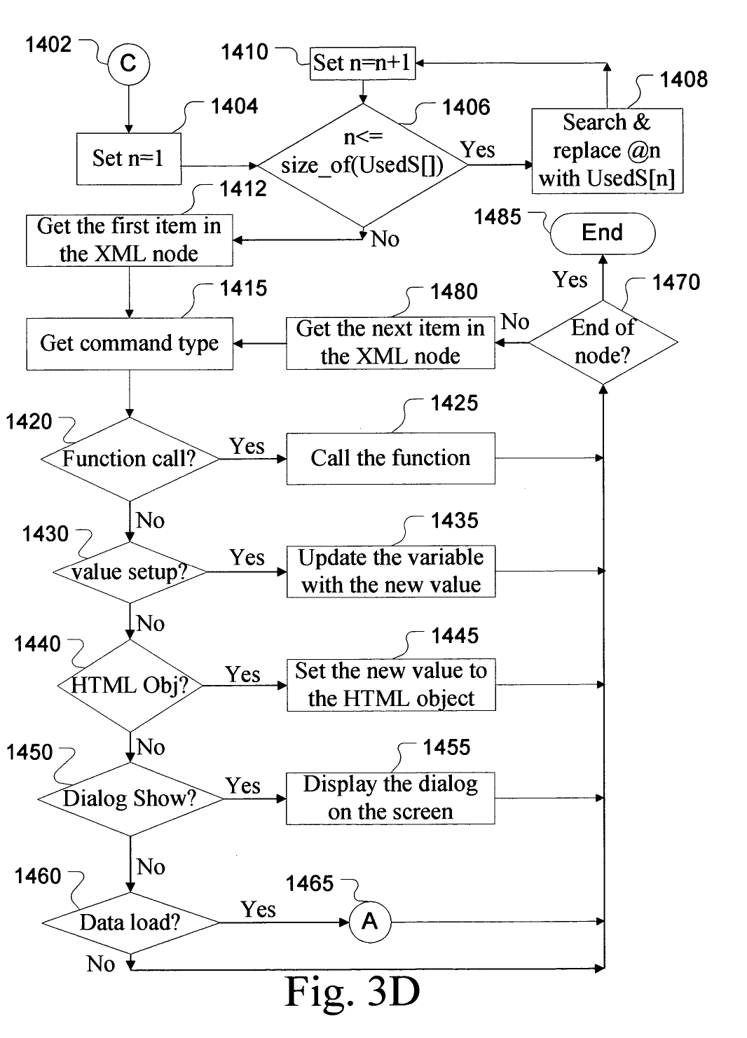

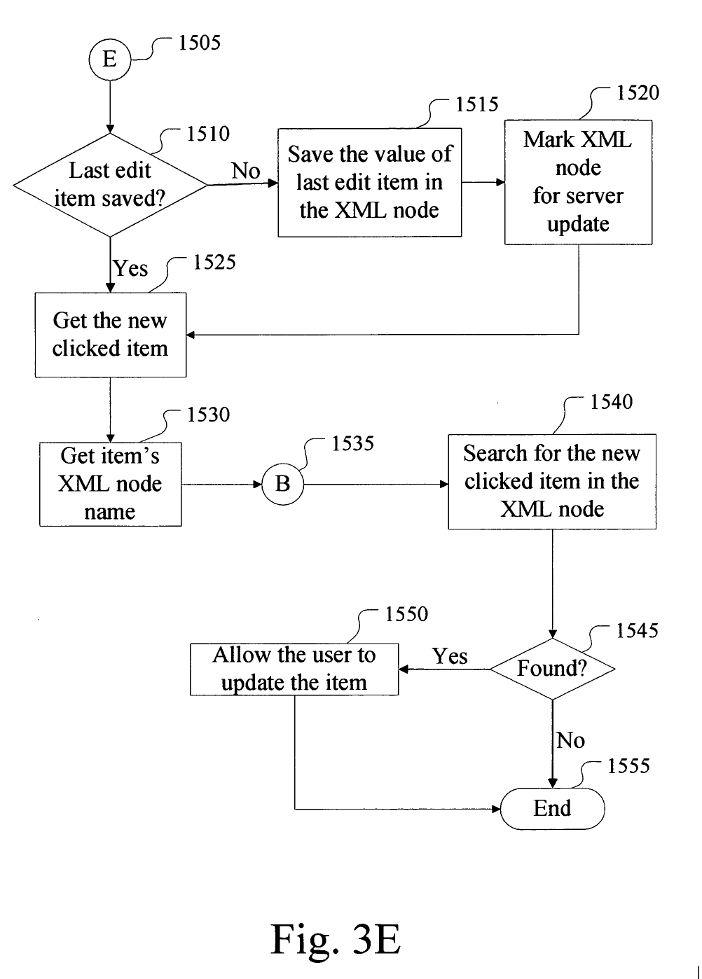

When a web user connects to the first HTML page on the application's web server, the application's code will be loaded and executed on the web browser. The browser will fetch from the web server the instruction data set which contains layout & content data for displaying the HTML page. The generation of HTML pages from layout & content data is described later in FIG. 3D. System init for the admin program (FIG. 2 & FIG. 3E) is the same as described before, except that additional code is loaded to support the added functionality.

3. Abstract of an Editable Multi-Server System

FIG. 2 describes the abstract system overview, the figures that flow this one will describe an implementation of this abstract system. The system waits till a web user clicks on an item in the web page (1010), then a check is done (1015) to determine if the system is in ‘edit mode’, if true then the previews changes (if exists) are saved to the current content file (1020), then the system will allow the admin user to make additional changes on the screen (1025).

If the system isn't in the ‘edit mode’, the layout name & parameters are retrieved from the attributes of the clicked item (1035), then a search is done for the layout name in the local cache storage (1040), if item name was found in the cache, it will be fetched from the cache (1045). If needed, additional changes can be done on the data before processing it (1050), this step can be used to allow override of information in the layout data in order to achieve code reuse (it will be describe in FIG. 3B).

The next step (1080) is to process the data and to execute the screen updates and other instructions stored inside the layout or content data. The layout or content data can contain instructions to load additional layout or content data (this way a layout can be composed from a collection of layouts, or one layout can contain instructions to load content from different sources), a check is done to determine if more data is needed (1085), if false then the process ends (1030), else a search is done for that data in the local PC cache (1040). If the searched data (1040) can't be fetched from the cache, the browser will try to fetch the data from the web server (1055), if the data fetching was successful (1060), the received data will be saved in the cache (1065), and processed (1050).

In cases that the web server can't deliver the data (1060), a check will be done to determine if more alternative servers exists (1070), if true the process will try to fetch the data from an alternative server (1055), if false an error message will be sent back (1075).

4. Detailed Explanation of the Invention Implementation

FIG. 3A describes the event filter. When a web user clicks on an item in the HTML page (1105), a check is done (1110) to determine if the system is in ‘edit mode’ (using the ‘edit mode’ for updating & managing the web site is described in FIG. 3E). If the system is in ‘edit mode’ the system will do page editing (1130). If the system is in ‘normal mode’, the system will look for the ‘cmd’ tag (1115) of the clicked object (this tag is described in FIG. 3B), if the ‘cmd’ tag doesn't exist it means that there is no action associated with this object and the process ends (1125), otherwise (1120) the system will parse the ‘cmd’ tag (described in FIG. 3B).

FIG. 3B describes the handling of the ‘cmd’ attribute of the clicked item. This attribute is used for describing the action associated with each object on the screen (e.g., opening a new web page when a menu item is clicked), this attribute can use the following format: Cmd=item#value;item#value (e.g., Cmd=DATA#NewsLayout;file1#NewsContent). In this implementation the Cmd attribute uses the reserved word ‘DATA’ to distinguish a layout/content data fetch from other instructions.

First the DataNode variable (DataNode is a XML variable that stores the instruction data set, which contains the layout data and content data) is initialized (1210) with a Null value. The process splits the ‘cmd’ attribute string to list of items (1215), using the semicolon char as an item separator (e.g., if {Cmd=DATA#NewsLayout;file1#NewsContent} then after the Cmd split {CmdItem1=DATA#NewsLayout, CmdItem2=file1#NewsContent}). If the list isn't empty (1220) the first pair of ‘item’ & ‘value’ is extracted (1225) from the ‘cmd’ list of items, if ‘item’=‘DATA’ (1230) then the name of the layout or content data (stored inside the ‘value’) is passed to the Cache Manager (described in FIG. 3C) for fetching the XML data node, the instruction data set result returned by the Cache Manager (1235) is added to the variable DataNode (1240).

Future versions may use additional reserved words, all unmatched items are used as a search & replace items (1250), this allows better reuse of the layouts, by replacing items in the layout (for example using “% file1 %#news” in the cmd attribute, results in replacing the % file1 % string with a file name called ‘news’, so the same layout can be used with different content files).

When the handle of the current ‘Cmd’ list item finish, the process moves to the next item (1245), if the ‘Cmd’ list is empty (1220), the XML node is sent for parsing & displaying on the web page (1255) as described in FIG. 3D.

FIG. 3C describes the Cache Manager. This process is responsible for retrieving & saving instruction data set in the local application cache. If the instruction data set was not found in the local application cache, then it is fetched from the web server or other storage device. If the current server (or other storage device) fails to supply the need data and alternative server exists from the same servers group, then the alternative server (or storage device) will be used on the current data fetch. If the current server supplied the needed data, but not within a reasonable time and alternative server exists from the same servers group, then the alternative server will be used on the next data fetch.

Two global arrays are used by this process:

ListS[N]—A two dimensional array, each ListS[N] item point to a array of alternative servers that belong to the same group. Each server group consists of alternative servers that store the same replicated copy of the instruction data set. Each ListS[N] item has an internal variable that points to the current used server (in each ListS[N] item). The internal variable behaves like a cyclic list pointer, so when the list pointer reaches the last item in the list, it returns to point to the first item in the list.

UsedS[N]—An array for indicating the current used server in each ListS[N] item. Each UsedS[N] item stores the value of the current user server, from the group of servers indicated by the ListS[N] item

This process uses a @N prefix in the XML data node name, to support advanced capabilities such as multi-server configuration, fault tolerance & load balancing. A XML node name with a @N prefix, indicates that it uses item number N (N can be any number greater then 0) in the ListS array, that stores one or more URL address (the URL's can be in the same domain name, or on different domains). If a ListS[ ] item contains more then one URL, it means that the system has alternative servers that can supply the same information (e.g., if {NodeURL=@8ServerData.php} and {ListS[8]=http://www.Domain1.com; http://www.Domain2.com} then NodeURL can use two address {http://www.Domain1.com/8ServerData.php} and {http://www.Domain2.com/8 ServerData.php}).

On normal usage UsedS[N] has the same value as the value indicated by the ListS[N] pointer, but when the current server has a slow respond speed, ListS[N] pointer is advanced to the next server in the same group, while UsedS[N] still retain his value, this will allow the system to continue using the slow server (stored in UsedS[N]), but to check for alternative server on the next instruction data set fetch from the same server group (described later in step 1394).

The algorithm gets a XML node name (a request string that can be a URL or file name) as an input string (1305), and checks to see if the current XML node name is already in the cache (1310), if it's in the cache, the XML node (instruction data set) is fetched from the cache (1315) and returned to the calling process (1320).

In case the XML node isn't in the cache (1310), a check is done (1325) to determine if there is a need to set the URL prefix (URL prefix is used in multi-server configuration), if true then the try_count variable (1330) is initialized to 1 (the counter is used to count how many servers from the list where tested), the value of the server URL is stored in UsedS[N] (1332), then the prefix of the current node URL (@N) is replaced with the value of UsedS[N] (1334). For example, if URL=@8 ServerData.php and ListS[8]={http://www.Domain1.com/; http://www.Domain2.com/}, that means that the @N prefix is set and that N=8, then the current used item is taken from ListS[8] and will be replaced in the URL string, the final URL can be URL=http://www.Domain1.com/ServerData.php in step 1334.

In step 1325, if there is no need to set the URL prefix (there is no @N prefix) then the XML node (instruction data set) will be fetched from the default data server (can be also the same web server that stores the application's code).

The next step is to fetch the data from the web server, first the download timer is initialized (1335), this timer is used to identify a download timeout situations, then the data is fetched from the web server (1340). After the data fetch is done, the download timer is stopped (1345), and the download speed is calculated (1350) using a formula such as ‘Speed=(data size)/(download time)’ and will be used later for load balancing (if alternative servers exists in the same group of servers) or for error reporting.

If no error occurred during the XML data load (1355), the calculated download speed is compared to a minimum speed value stored in the system (1360), if the current speed is greater then that stored value, it means that the response time of the current server is within the norm (the other option will be described later in the load balancing section).

The next step is to get the cache attribute (1365) from the XML data node, and check it (1370), to see if this XML node should be saved in the cache for later use (1375), the last step of this process is to return the fetched XML node to the calling process (1320).

5. Fault Tolerance

The following is the implementation of the fault tolerance feature of the system. If the current server doesn't respond for any reason, an attempt is made to access another server from the same group of servers (all the servers in the same group store the same data). The system instructs the client to fetch data from an alternative server in order to overcome a server problem.

In FIG. 3C, if error occurred during the data load (1355) the check “try_count<SizeOf(ListS[n])” is done to determine if there are more alternative servers that where not used yet (during this fetch cycle), to deliver the current data fetch (1380), if no additional server exists then a server error message is set (1384) and returned to the calling process (1320). If there are more alternative servers that where not used in the current data fetch (1380), then the try_count variable is incremented by 1 (1386), ListS[N] internal pointer is advanced to the next item (1388), the value of the server address is stored in UsedS[N] (1332), then the prefix (@N) of the original node URL is replaced with the value of UsedS[N] (1334).

6. Advanced Fault Tolerance

When the storage tag is not used, the system will always try to get the real time data from the web serves. The system can be modified to be able to use the last received real-time data, if the connections to the web servers is lost. This can be done by doing the following modifications: Step 1310 will search for the URL in the cache memory and fetch the instruction data set only if it has the storage tag. Step 1370 will enable to save all the instruction data sets in cache memory, even if the storage tag is not set. Step 1375 will be able to replace old instruction data set with a new one. If server errors occur in step 1380, then step 1384 will search for the URL in the cache memory and fetch the instruction data set (even if it does not have the storage tag). If the URL was not found in step 1384, then the XML node will contain an error message.

7. Load Balancing

The following is the implementation of load balancing feature in the system, unlike most other load balancing solutions that are based on performance tests on the server side, this solution tests all the network path from the client to the server and back. In this approach optimized utilization is achieved by redirecting the clients to another server, if the current server responds too slowly (compared to a predefined byte per second speed value). If the current server responds well (data received with no errors) but not in a reasonable time (because of network latency in the current client/server network path, server is overloaded or any other reason), an attempt will be made in the next data fetch to access another server from the same servers group (stores a replicated copy of the current server data).

In FIG. 3C, if the calculated download speed is smaller then the minimum speed value stored in the system (1360), it mean the server is functioning well (because there where no server errors in step 1355), but the server response time is too slow (due to high CPU load on the server, network latency between the client/server network, hackers attack on the server or any other reasons), in that case a check will be made (1390) to determine if the current XML node URL support servers group (the current URL uses the @N prefix), if true the server list pointer will be advanced to the next server (1394) in the list (so the next time a data request will be made from the same servers group, the next server in the group's list will be used instead of the current one).

8. Parsing the Data & Displaying the Web Page

FIG. 3D describes the process for parsing the data & displaying the web page, this process is called by FIG. 3B. The algorithm gets as an input (1402) a XML data node (instruction data set) that contain commands for data processing & displaying. First the variable “n” is initialized to 1 (1404), it will be used later to iterate all the server prefixes stored in the UsedS[ ] array (array that stores the names of all the current used servers, see FIG. 3C). Next a check is done to determine if multi-server configuration exists, by checking if ‘Size_of(UsedS[ ])>=1’ (1406), if true then for each server group a search and replace is done (1408), by replacing the @n prefix (e.g., @1 and @2) inside the URL of the XML data node, with the current server prefix (e.g., www.StockList.com/, www.StockInfo.com/), the final result will be a full path to the web item (e.g., @1 stocks.xml, @2data.xml will be converted to www.StockList.comlstocks.xml, www.StockInfo.com/data.xml). The loop counter is incremented (1410) till all URL prefixes in the node are replaced.

The first sub-node is fetched from the XML data node (1412), then the command attribute is extracted from it (1415) and compared against various options:
a. If it's a function call command (1420), then the function is called with the attributes that are taken from the current XML sub-node (1425).
b. If it's a value setup command (1430), then the value is set by using the attributes that are taken from the current XML sub-node (1435).
c. If it's a HTML object setup command (1440), then the HTML object value is set by using the XML attributes that are taken from the current sub-node (1445), this step is used for setting values (or HTML layout fragments) to HTML objects such as: image, label, div, td and many others.
d. If it's a dialog show command (1450), then the dialog is displayed by using the attributes that are taken from the current XML sub-node (1455).
e. If it's a data load command (1460), then the a data is loaded and parsed, the name of the data node is taken from the attributes of the current sub-node, this name is passed in the format of the ‘cmd’ attribute (as in FIG. 3B). this step can be used for nesting XML data node inside another XML data node to achieve code reuse and reduce the code size.

When the process of the current sub-node finishes, and there are more sub-nodes in the main XML node (1470), then the next sub-node is fetched from the main XML node (1480) and processed (1415).

9. Edit Mode Operation

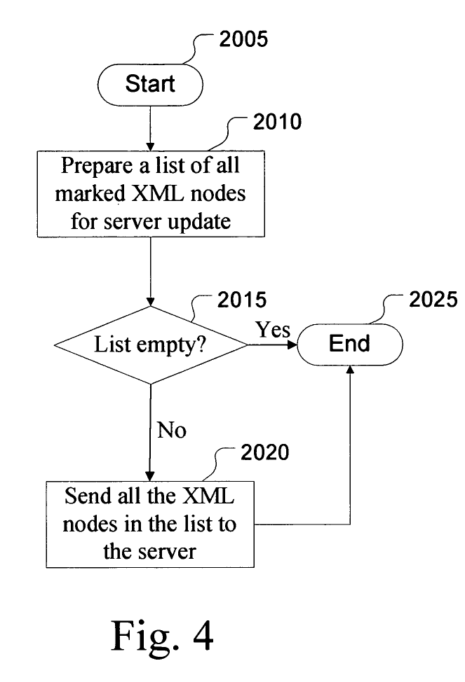

FIG. 3E describes the process for web page editing, this process is called from the process in FIG. 3A. First a check is done to determine if the last edited HTML item was saved (1510), if not then the item is first saved in the content file (1515) inside the instruction data set, and the instruction data set that contain this item is marked (1520) for server update, by setting the instruction data set storage tag (it will be sent to the server on the next server update session as seen in FIG. 4).

The new clicked item is retrieved (1525) and the XML node name (instruction data set) is fetched (1530), by scanning all parent elements of the clicked item (objects inside the HTML page), and seeking for the attribute named ‘file’ (this attribute stores the name of the content node file associated with this screen). Then the node is fetched by the cache manager (1535), a search for the clicked item is done on the fetched XML node (1540), if not found (1545) then this item can't be edited, if found then the item's state is changed to updatable state (1550) and the web browser UI will allow the admin user to make changes to the clicked item.

FIG. 4 describes the algorithm for sending the updated XML nodes to the web server. It is called (2005) when the server update button is pressed in the management screen of the admin program. First it prepares a list of all the instruction data sets with the storage tag attribute (2010), if the list is not empty (2015), it sends all the instruction data sets to the server (2020) by using FTP or other network protocol.

10. Deployment Layout

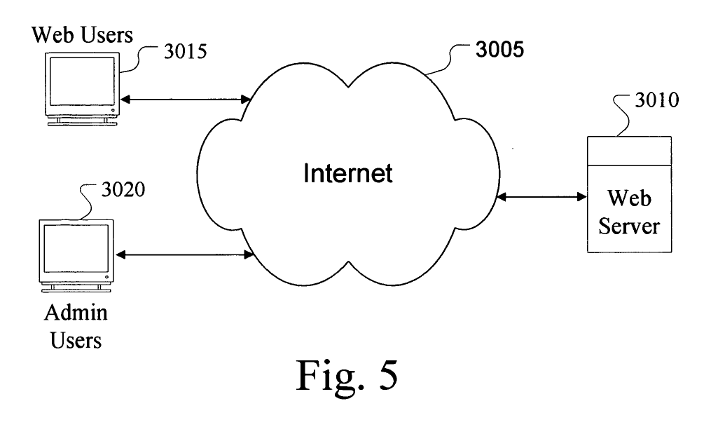

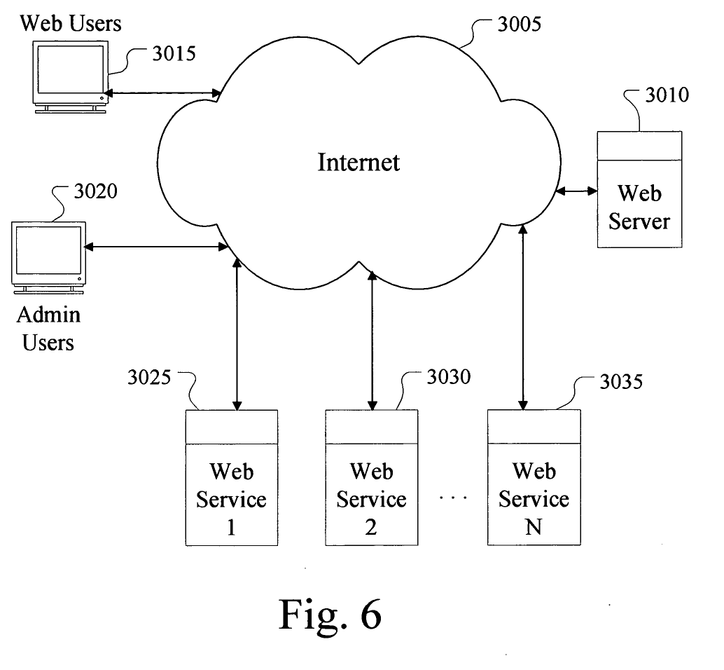

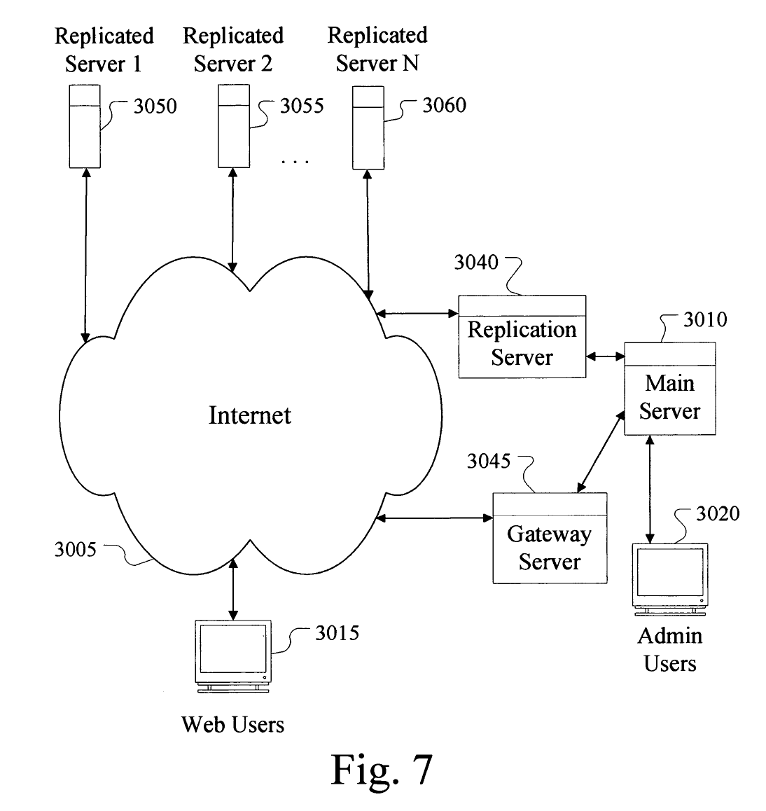

FIG. 5, FIG. 6 & FIG. 7 describes the various deployment layout of the system. The simplest layout is the Basic layout described in FIG. 5, in this layout there is only one web server (3010), that give services to the web users (3015), this server is updated by the admin users (3020). This layout doesn't implement advanced features such as fault tolerance or load balancing, and is the same as used in simple HTML web sites.

A more advanced layout is described in FIG. 6. This layout is the same as described in FIG. 5, except that additional web services (3025, 3030 & 3035) can be easily integrated inside the system, by using URL's that points to specific web server.

11. Fault Tolerance and Load Balancing Deployment Layout

FIG. 7 describes a fault tolerance and load balancing deployment layout. In this layout, the web users (3015) do not have direct access to the main server (3010), instead (by using the @N prefix as described in FIG. 3C), the web users receive the data from one of the replicated servers (3050, 3055 & 3060), if one of the servers fails to deliver the data for any reason (see step 1355 in FIG. 3C) or one of the servers has slow response time (see step 1360 in FIG. 3C), the next server in the @N list will be used (as described in FIG. 3C). The replication server (3040) is responsible for replicating all the needed files & databases from the main server (3010) to the replicated servers (3050, 3055 & 3060), this replication server is a shelf product that can be bought and integrated with the current system. If the deployed application must also receive data from web users (3015), then a gateway server (3045) can be added, this server is used as a buffer between the web users (3015) and the protected main server (3010), when sending or receiving data from the main server (3010) and can also protect the main server from hackers attack by hiding the main server from the web users.

Since this layout does not allow direct access to the main server (3010), it is recommended that the admin users (3020) will use Intranet connection (or other ways) to access the main server (3010) without directly connecting the main server to the Internet.

### CONCLUSION, RAMIFICATIONS, AND SCOPE

Thus the reader will see that the present invention provides a method for creating web sites with better performance and offer advanced features that are not available in web sites that use standard HTML technology. While the above description contains many specificities, these should not be construed as limitations on the scope of the invention, but rather as an exemplification of one preferred embodiment thereof. Many other variations are possible. For example creating fast web applications that behave like local PC applications because, they have no blinking effect when the web pages changes. Accordingly, the scope of the invention should be determined not by the embodiment(s) illustrated, but by the appended claims and their legal equivalents. Now that a preferred embodiment of the present invention has been described, with alternatives, various modifications and improvements can be done by those that are skill in the art. Thus, the detailed description should be understood as an example and not as a limitation. The proper scope of the invention is defined by the following claims.

What is claimed is:

1. A method for creating an application that run inside a web browser in a client machine, comprising:
(a) providing a computer code which is able to execute said application inside said web browser;
(b) providing an instruction data set which is able to store instructions for updating said web browser display and which is able to store code elements to use with said application;
(c) providing a storage device which is able to retrieve said computer code and said instruction data set, said storage device is consisted from one or more of the following group of web server, file server, database, cd-rom, hard-disk and other media storage;
(d) providing a request string which is able to locate said instruction data set stored in said storage device;
(e) providing a cache memory which is able to store said request string and corresponding said instruction data set inside said application;
(f) providing a storage tag inside said instruction data set which when set is able to indicate to said application to store said instruction data set in said cache memory;
(g) fetching from said storage device said computer code;
(h) executing said computer code inside said web browser;
(i) creating said request string for said application initialization process;
(j) providing a request fetch controller which will:
(I) fetch from said cache memory said instruction data set if said request string already exists in said cache memory, and
(II) fetch from said storage device said instruction data set if said request string not exists in said cache memory;
(k) providing a request storage controller which will store said instruction data set in said cache memory if said instruction data set contains said storage tag;
(l) providing a parser controller for parsing said instruction data set, which will:
(1) execute a display update instructions for updating said web browser display, and
(2) execute a code update instructions for updating code elements inside said application, and
(3) execute a request instruction for fetching an additional instruction data set, by repeating step (j) for each said request instruction; thereby providing the ability to do nesting inside said instruction data set, and
(4) repeating said parser controller steps (1), (2) and (3) until all said instruction data sets are parsed;
whereby said computer code and said instruction data set fetched from said storage device will contain all the necessary code and data to execute said application inside said web browser, and
whereby said application running inside said web browser will be able to support smooth web page navigation, by replacing screen fragments inside said web browser display, without having to replace the entire displayed screen, and
whereby said application running inside said web browser will be able to reuse said instruction data set in order to optimize bandwidth consumption from said storage device, and
whereby said application running inside said web browser will be able to support nesting with said instruction data set in order to reuse existing said instruction data set inside another set of said instruction data set.

2. The method of claim 1, wherein said instruction data set comprised of one of the two types of data:
(a) fixed layout data that stores code elements and fragments of display layout data;
(b) changeable content data that can be used with said fixed layout data;
whereby said instruction data sets can be divided into two types, one type that is used for storing template layout and code elements, and the second type that is used for storing changeable content data that can be merged with said fixed layout data.

3. The method of claim 1, wherein said computer code is written using a computer code language selected from the group consisting of java-script, j-script, vb-script and java.

4. The method of claim 1, wherein said client machine is selected from the group consisting of pc computer, handheld devices, palmtop devices, set-top boxes, web tv, mobile phones and so-called internet appliances.

5. The method of claim 1, farther comprising the step of connecting to alternative storage devices on said instruction data set fetch error; whereby enabling said application to recover from said instruction data set fetch errors without losing data.

6. The method of claim 1, farther comprising the step of connecting to alternative storage devices when connection to said storage device suffers from transaction delay problems.

7. The method of claim 1, farther comprising the step of providing an additional admin code for an admin program, which will:
(a) allow making changes on a web page inside said web browser, and
(b) allow inserting images and previewing them before submitting to said storage device, and
(c) insert the changes inside said instruction data set, and
(d) store said instruction data set inside said storage device.

8. The method of claim 1, wherein the system can be partially or fully initiated & activated from one or more of the following group consisting of internet web server, intranet web server, file server, cd-rom, hard-disk and other media storage.

9. The method of claim 1, wherein said instruction data set is stored on a xml text file.

10. The method of claim 1, and further comprising the step of encrypting said instruction data set, on said storage device and wherein the step of fetching said instruction data set, from said storage device comprises decrypting said instruction data set inside said client machine.

11. The method of claim 1, and further comprising the step of dynamically creating said instruction data set from a database.

12. The method of claim 1, wherein said instruction data set display commands are based on the hypertext mark-up language.

13. The method of claim 1, wherein said request string is based on a uniform resource locator and can be created when a web user clicks on a hyperlink inside the hypertext mark-up language page.

14. The method of claim 1, wherein said instruction set contains preload data, to optimize storage device transactions, whereby said cache memory can contain preloaded said instruction set that might be used later.

15. A method according to claim 1, wherein said instruction set is always saved inside said cache memory and said instruction set will be fetched from said cache memory, if said instruction data set contains said storage tag or if said storage device is disconnected.

16. A method for creating an application that run inside a web browser in a client machine, comprising:
(a) providing a computer code which is able to execute said application inside said web browser;
(b) providing an instruction data set which is able to store instructions for updating said web browser display and which is able to store code elements to use with said application;
(c) providing a storage device which is able to retrieve said computer code and said instruction data set, said storage device is consisted from one or more of the following group of web server, file server, database, cd-rom, hard-disk and other media storage;
(d) providing a request string which is able to locate said instruction data set stored in said storage device;
(e) providing a cache memory which is able to store said request string and corresponding said instruction data set inside said application;
(f) executing said computer code inside said web browser;
(g) providing a request fetch controller which will:
(I) fetch from said cache memory said instruction data set if said request string already exists in said cache memory, and
(II) fetch from said storage device said instruction data set if said request string not exists in said cache memory;
(h) providing a request storage controller which will store said instruction data set in said cache;
(i) providing a parser controller for parsing said instruction data set, which will:
(1) execute a display update instructions for updating said web browser display, and
(2) execute a code update instructions for updating code elements inside said application, and
(3) execute a request instruction for fetching an additional instruction data set; thereby providing the ability to do nesting inside said instruction data set, and
(4) repeating said parser controller steps until all said instruction data sets are parsed;
whereby said computer code and said instruction data set fetched from said storage device will contain all the necessary code and data to execute said application inside said web browser, and
whereby said application running inside said web browser will be able to support smooth web page navigation, by replacing screen fragments inside said web browser display, without having to replace the entire displayed screen, and
whereby said application running inside said web browser will be able to reuse said instruction data set in order to optimize bandwidth consumption from said storage device, and
whereby said application running inside said web browser will be able to support nesting with said instruction data set in order to reuse existing said instruction data set inside another set of said instruction data set.

17. The method of claim 16, farther comprising the step of connecting to alternative web server on said instruction data set fetch error; whereby enabling said application to recover from said instruction data set fetch errors without losing data.

18. The method of claim 16, wherein said instruction set contains preload data, to optimize storage device transactions, whereby said cache memory can contain preloaded said instruction set that might be used later.

19. The method of claim 16, farther comprising the step of providing an additional admin code for an admin program, which will:
(a) allow making changes on a web page inside said web browser, and
(b) allow inserting images and previewing them before submitting to said storage device, and
(c) insert the changes inside said instruction data set, and
(d) store said instruction data set inside said storage device.

20. The method of claim 16, and further comprising the step of dynamically creating said instruction data set from a database.
